(19) United States
(12) Patent Application Publication
(10) Pub. No.: US 2007/0279593 A1
(43) Pub. Date: Dec. 6, 2007

(54) Visual presenter with built-in central control system

(76) Inventors: Weihua Li, Novi, MI (US); Jingying Gong, Walled Lake, MI (US); Ying Shi, Windsor (CA)

Correspondence Address: Weihua Li, PO. Box 1137, Novi, MI, 48376, US

(21) Appl. No.: 11/445,697

(22) Filed: Jun. 3, 2006

(51) Int. Cl. G03B 21/14

(52) U.S. Cl. 353/22

(57) ABSTRACT

This invention discloses a visual presenter with built-in central control system capable of remotely controlling external display device, operating image capturing device, and switching input sources. The conversion of input video format into output video format is in operation even when the visual presenter is in Stand-by mode. A universal remote is further incorporated to consolidate the operation of other external devices. An electronic whiteboard can be connected via attached PC to be displayed on external projector greatly improved the multimedia experience.

### CROSS-REFERENCE TO RELATED APPLICATIONS

### U.S. Patent Documents

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to visual presentation device with a built-in central control panel designed to switch and convert multiple audio/video inputs to designated outputs so that the input can be displayed on external devices such as a projector.

2. Background of the Invention

Presentation of enlarged images of documents or visuals has been an important means of communication. Whether they are for business or for home use, devices that aid presentation such as overhead projectors become increasingly pervasive. These tools have evolved from simple optical system with light source to sophisticated electronic system with image capturing device. These electronic systems offer much greater functionality than their predecessors for their ability to capture and manipulate images of objects other than transparencies. Another important feature is that the electronic systems can produce output signals commonly accepted by projectors dedicated for displaying video signals. Size and weight reduction also contributed to the popularity of these devices as they become integral part of the presentation experience.

A dominant characteristic in modern presentation techniques is of multimedia in nature incorporating audio, static images, video and live demonstration. Number of devices capable of producing video signal has also been increasing. VCRs, computers, DVD players, camcorders, etc. can all act as video sources. The format of video sources has also been consolidated into a limited few.

Many dedicated presentation venues such as conference centers and classrooms are mostly multimedia capable. They accept image signals from different sources and in different formats. Because of this capability, presenters enjoy the freedom in selecting video media without being concerned about not being able to display the images.

The multimedia capability comes at a cost where linking the desired sources at the right moment to the right devices and displaying at the designated display unit becomes error prone and time consuming. Additionally, the display unit is often ceiling mounted and can only be controlled by a remote control which can also easily get lost among many other remote controls for devices such as VCRs and DVD players. This situation can put any presentation at risk particularly for those live presentations where smooth and prompt transitioning/switching of sources is a mandate.

This invention reveals a logic way of consolidating multiple input sources along with a central control system into a single visual presentation platform making the switch of different sources and control of external display devices fast and secure.

### BRIEF SUMMARY OF THE INVENTION

This invention discloses a visual presenter that incorporates the functionalities of both an electronic visualizer and a central control system. In contrast to having a separate control center where managing the cables and controlling devices remotely through remote controls can be a challenging endeavor, this presenter brings the switches and controls together to the presenter's fingertips.

The visual presenter's electronic visualizer component comprises a platform with a flat surface where documents or objects (target) can be placed. The platform can be made of a semi-transparent surface with backlighting. The target can also be illuminated by additional foreground lights. An image capturing device such as CCD with optical lenses at a distance from the platform surface converts the target optical image to video signal to be displayed through an external display such as a projector. This platform allows presenter to place paper, transparent documents or other 3D objects on the platform and the image of target will be displayed.

Meanwhile, the visual presenter's central control center comprises a control system on which plurality of buttons are logically placed and input/output connectors for multiple video and audio formats. The buttons on the control system provide four basic functions: 1) media control; 2) visualizer image capturing control; 3) external display unit control; 4) power on and off.

The media control buttons allow the presenter to switch the active image/video to any one of the input connectors in addition to the image capturing device.

The visualizer image capturing control buttons allow the user to have full control of the said visualizer such as zooming, freezing and the background and foreground lighting. A particular assignment of the functions in this group comprises: 1) Mirror Image; 2) Dynamic/Static Mode; 3) Split Screen; 4) Freeze Image; 5) Negative/Positive; 6) Freeze the Top ⅛ of the screen; 7) Move image up; 8) Move image down; 9) Focus adjustment.

The control buttons for the external display unit allow the presenter to remotely control the external display unit such as a projector through a cable if so equipped. A particular assignment of functions to the buttons in this group comprises: 1) Projector Power On/Stand-by; 2) Projector input select.

The active image/video signal is presented at the chosen output connector where an external display unit can be connected. The input formats are electronically converted to the chosen output connector's format. When input format is the same as output format, conversions may not be necessary. These conversions include 1) S-Video to RGB; 2) Composite Video to RGB;

When the visual presenter is in “Stand-by” mode, the conversion of video formats from input to output continues to be in operation. This feature allows the visual presenter to act as a hub for linking inputs and outputs without turning on the presenter.

Stereo audio inputs are individually paired with video inputs. The media control buttons which select video inputs also select the paired audio at the same time. The audio output is always connected to the audio paired with the active video.

The capability of accepting RGB input allows direct connection with personal computers (PC). This type of connection further allows the attachment of other presentation relevant devices such as electronic whiteboard through USB cable.

A universal remote control which can be programmed to control attached devices such as DVD player and VCR as well as external projector is incorporated in the visual presenter extending user's control of attached devices.

With the multiple input conversion capability and built-in central control system, a particular embodiment of this invention can enhance the multimedia presentation experience, minimize or avoid mistakes in selecting input sources and reduce the clutter of cables and wires.

### BRIEF DESCRIPTION OF THE DRAWINGS

FIG. 1 is an illustration of the invention which combines the functionalities of a visualizer and a media control box. The resulting visual presenter is shown with foreground lights and image capturing device in operation positions. The built-in central control system and the side input panel are shown in this view. The rear connection panel is not shown in this view but shown in FIG. 2.

FIG. 2 is a schematic diagram illustrating a typical connection layout where input devices such as VCR, DVD player, and PCs and output projector along with electronic projector screen are shown.

FIG. 3 is a schematic diagram showing the connection and conversion of input video sources to the outputs.

FIG. 4 is a schematic showing the built-in central control system that allow user to have the full control of the overall operation of the presentation device including selecting input sources and operating external projector.

FIG. 5 is a schematic diagram showing the attached input devices and output projector.

FIG. 6 is a schematic diagram showing the connection between the visual presenter, external projector and electronic projector screen with RS232 cables used for controlling the projector and projector screen.

FIG. 7 is a schematic diagram showing the connections between the visual presenter and external PCs.

FIG. 8 is a schematic diagram showing the universal remote control controlling external devices such as VCR and DVD player.

FIG. 9 is a schematic diagram showing an electronic whiteboard connected to a PC which is connected to the visual presenter.

### DETAILED DESCRIPTION

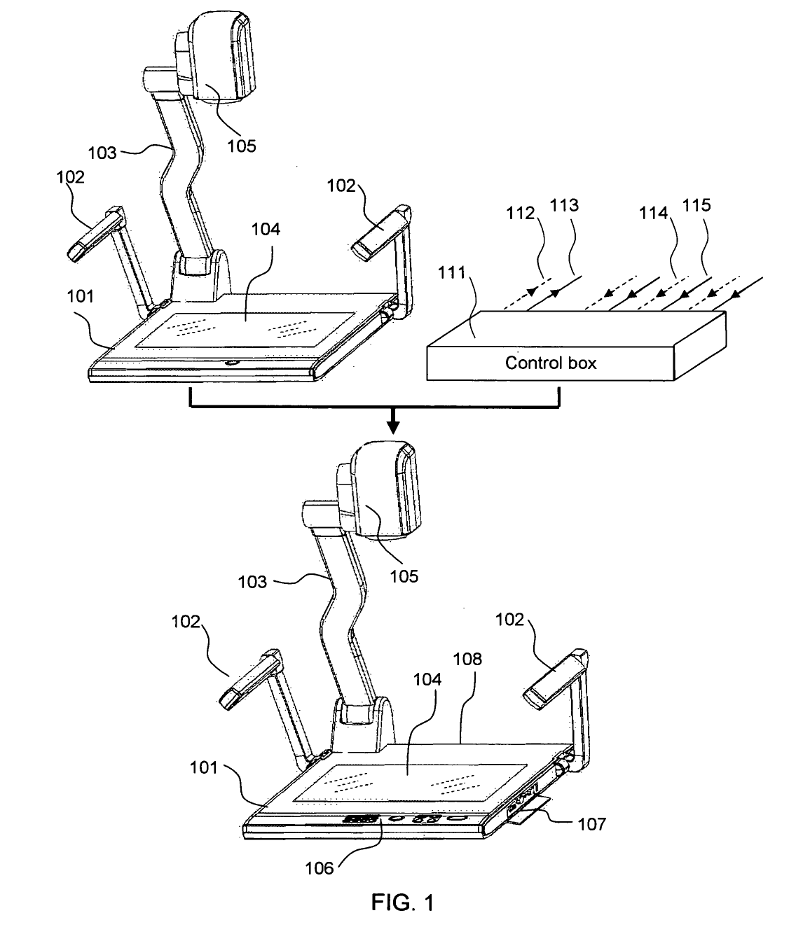

FIG. 1 illustrates a particular embodiment of the current invention as the result of combining the functionalities of a visualizer and a central control box. The visualizer comprises a platform 101 with foreground lighting 102 and image capturing device 105 and its support arm 103. Platform 101 has a semi-transparent or transparent flat surface 104 to allow the documents or other object to be placed. Underneath flat surface 104 there may be lights used as background lighting for displaying transparencies. Lights 102 provide the foreground lighting when displaying non-transparent documents or objects. An image capturing device some distance above flat surface 104 is used to capture the image of the object. A supporting arm 103 supports the device capturing device and can be rotated along the hinge to a position parallel to the platform surface when the image capturing device is not in use.

Also illustrated is a central control box 111 where multiple audio 114 and video 115 inputs are connected and converted to audio output 112 and video output 113.

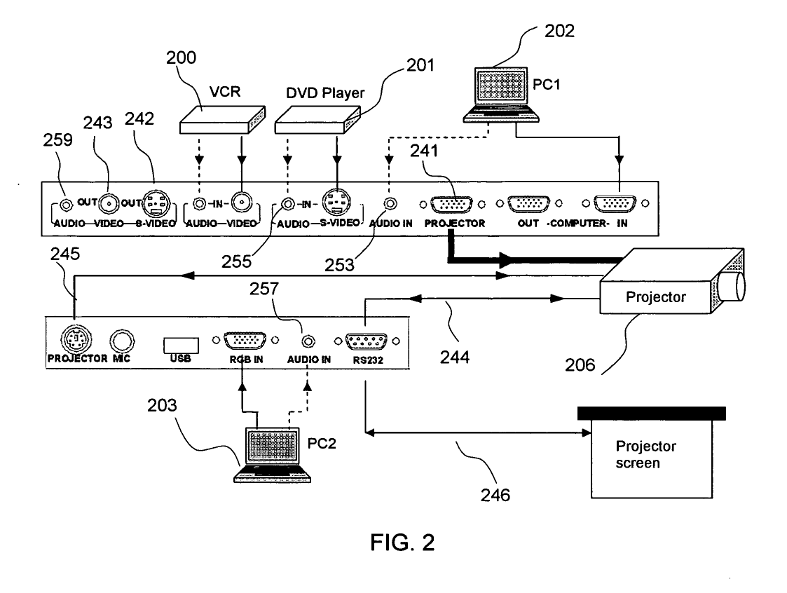

This invention combines the two separate devices into one visual presenter where it acts as a media center allowing various audio/video sources to be connected to the said visual presenter. In this particular embodiment, the central control and other functionalities are grouped into a built-in central control system 106 in front of the presenter. There are multiple input and output connectors of various formats attached to the sides of the platform. Side panel 107 and rear panel 108 (not shown in FIG. 1) contain the connectors as shown in FIG. 2.

A particular arrangement of various input devices and output projector 206 to the visual presenter is shown in FIG. 2. Both audio and video outputs from VCR 200 or DVD player 201 are connected to the corresponding input connectors of the same video formats. Up to two PCs 202 and 203 can be connected at the same time through the RGB input connectors.

Communication cables 244 and 245 in RS232 format are used to provide remote control capability of the often ceiling mounted projector to the visual presenter. The buttons that remotely control (power on/off a projector and switch projector input sources) the projector are part of the built-in central control system 106.

Communication cable 246 in RS232 format can also be used to control the up and down movements of an electronic projector screen.

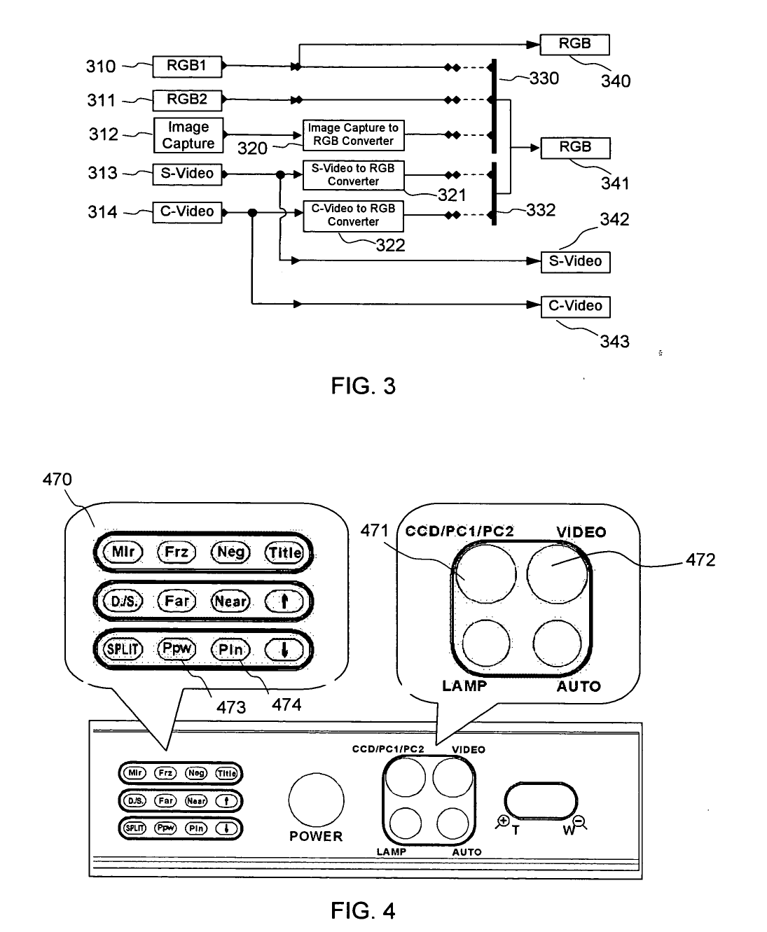

Converting various input formats into the desired output format requires conversion. FIG. 3 illustrates how input video signals are converted and switched to the output. Conversion of video formats takes place as soon as the input signal in present. A switch controlled by the media buttons in the built-in central control system 106 routes the desired input to the output connector. The formats for input and output include: RGB from PCs 310 and 311, S-Video 313, and Composite video 314. The image capturing device 105 is also one 312 of the inputs.

A typical output format is RGB 341 in FIG. 3 or 241 in FIG. 2 which is widely accepted by projectors. All the input formats can be switched to the RGB output format. The required conversions include: 1) image capturing device to RGB 320; 2) S-Video to RGB 321; 3) Composite video to RGB 322.

For output format S-Video 342 in FIG. 3 or 242 in FIG. 2, input formats are limited to S-Video. It is a straight pass-through connection and no conversion is required.

For output format Composite video or C-Video 343 in FIG. 3 or 243 in FIG. 2, input formats are limited to C-Video. It is a straight pass-through connection and no conversion is required.

The selection of the output and inputs is through the switches, 330 and 332 in FIG. 3, controlled by buttons 471 and 472 in the central control system as shown in FIG. 4. Each switch connects only one input source at any moment. Switch 330 and 332 are mutually exclusive to allow only one RGB output from sources 310, 311, 312, 313, and 314.

Another feature is that the conversion of video formats from input to output continues to be in operation even when the visual presenter is in “Stand-by” mode. Such feature allows the visual presenter to act as a hub for linking inputs and outputs without turning on the presenter.

All the media control functionalities are accessible through the built-in central control system as shown in FIG. 4. There are buttons dedicated for controlling the visualizer and external projector 470 and for switching inputs and outputs 471 and 472. In this particular embodiment, control buttons for the visualizer covers various functions: 1) Mirror Image; 2) Dynamic/Static Mode; 3) Split Screen; 4) Freeze Image; 5) Negative/Positive; 6) Freeze the Top ⅛ of the screen; 7) Move image up; 8) Move image down; 9) Focus adjustment.

The control buttons for the external display unit allow the user to remotely control the external display unit such as a projector through a cable if so equipped. A particular assignment of functions to the buttons in this group comprises: 1) Projector Power On/Stand-by 473; 2) Projector input select 474.

The buttons that allow the user to switch input sources are also located in this panel. Button 471 toggles among the two RGB inputs and image capturing device. Button 472 toggles between the S-Video and C-Video input sources.

Summary of the functionalities controlled by the central control system in FIG. 4

| To Control | Press | Results |
|---|---|---|
| Projector | Ppw | Turn on/off projector |
| | Pin | Switch projector input |
| Projector Screen | Ppw | Move up/down screen |
| CCD (Image | CCD | Visual presenter signal |
| capturing device) | | |
| PC1 | PC1 | PC1, Electronic Whiteboard |
| | | (if connected) |
| PC2 | PC2 | PC2 |
| 1^{st} Video | Video (1^{st} Time) | DVD (or 1^{st} Video Equipment)* |
| 2^{nd} Video | Video (1^{st} Time) | VCR (or 2^{nd} Video Equipment)* |

*Note: Universal remote control is provided for control of various brands and makes of VCRs and DVD players (power on/off, play, reverse, forward, pause, stop).

The advantages of this built-in central control system include: 1) allowing the user to quickly switch audio and video sources without having to physically disconnect and reconnect different cables; 2) providing the ability to remotely control the external projector; 3) fast and smooth transition of different video sources.

Audio signals can be connected through stereo jacks: 253, 255, and 257 in the side panel and rear panel (FIG. 2). The audio signals are mutually exclusive and only the one paired with the selected video source is passed through to the audio output connector 259.

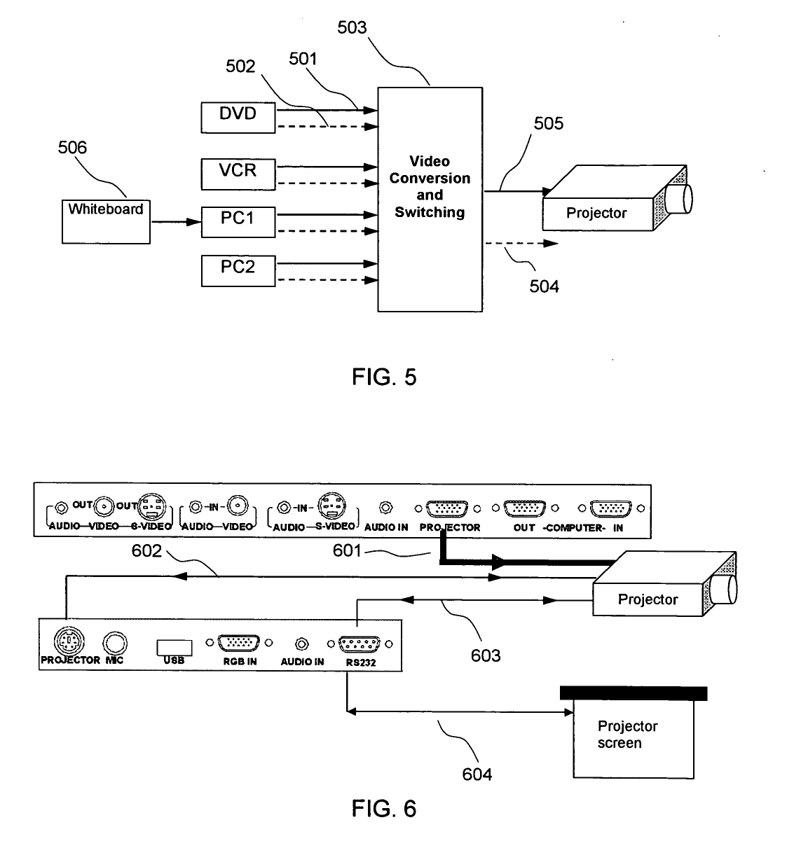

A typical connection layout is shown in FIG. 5 where various video sources 501 along with stereo audio 502 can be converted and switched through the processing unit 503 to video output 505 and audio output 504. A whiteboard 506 can be linked to a PC that is connected to the visual presenter. Such arrangement further enhances the multimedia capability.

Video connection to external projector is through a single RGB cable 601 as in FIG. 6. RS232 cables 602 and 603 link the presenter and the external projector establishing two way communication between them. The built-in central control system utilizes the communication to remotely control the projector (power on/off a projector and switch projector input sources). RS232 cable 603 links the presenter and the electronic projector screen, to control the up and down movement of the screen.

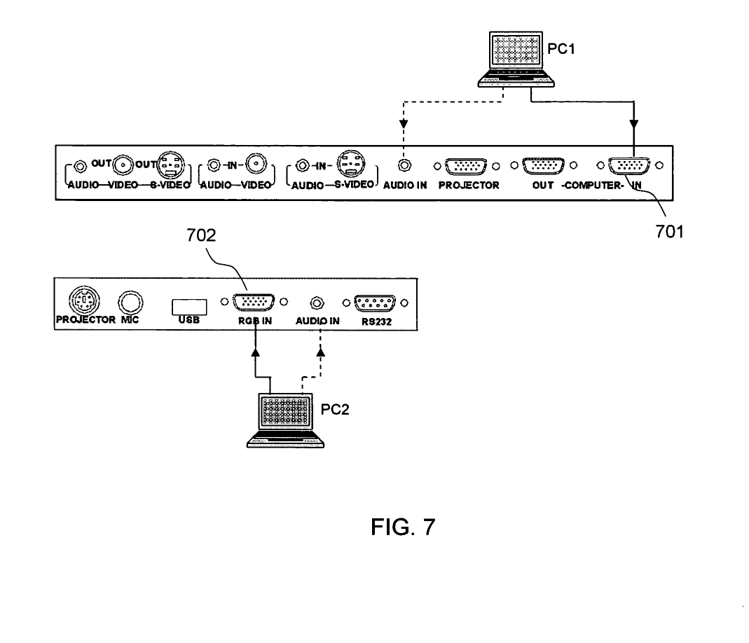

PC connection to the visual presenter is through the RGB inputs 701 and 702 as shown in FIG. 7. Multiple PCs can be attached at the same time. In this embodiment, up to two can be attached and their video and audio outputs can be selected to be displayed through a projector.

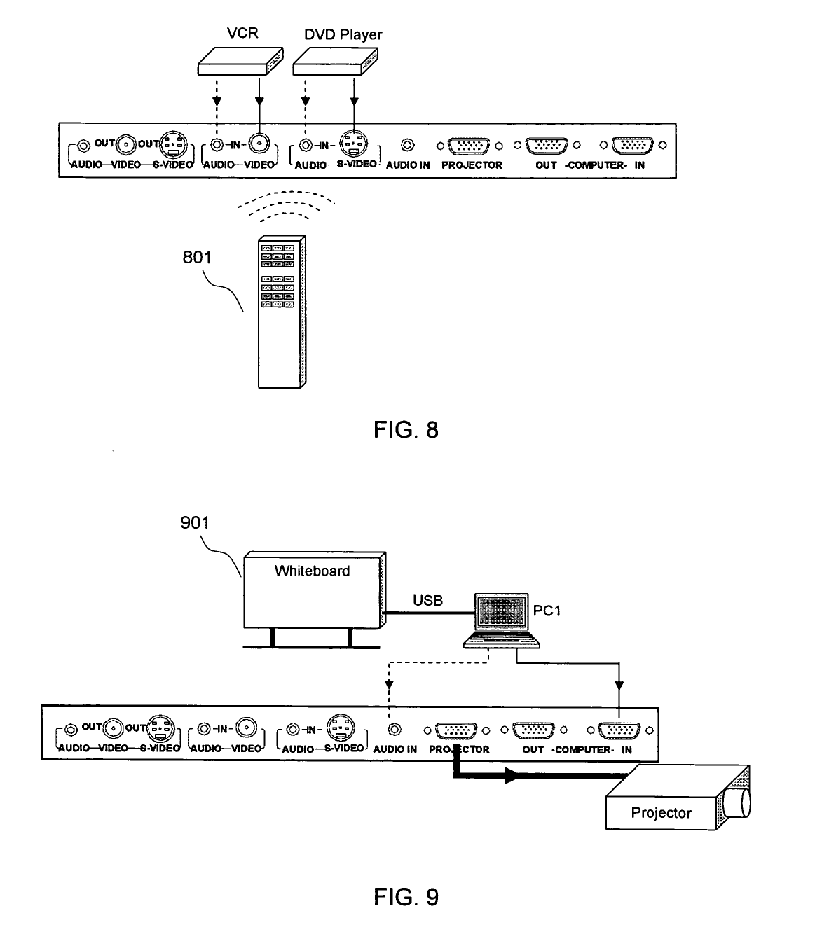

To further improve the user experience and consolidate the remote controls of various devices, a universal remote control 801 is also included in the visual presenter as illustrated in FIG. 8. With such remote control, the other remote controls for devices relating to presentation such as VCRs, DVD players of most brands and makes (power on/off, play, reverse, forward, pause, stop), and ambient lighting can be combined thus avoid confusion.

Electronic whiteboards have been a powerful means of presenting ideas and increasing the effectiveness of brainstorm sessions. This invention also includes a means to link an electronic whiteboard 901 to the visual presenter allowing the image to be display on the projector as shown in FIG. 9. The whiteboard connects to the visual presenter via a PC through USB cable. This inclusion of electronic whiteboards further enhances the multimedia capabilities of the visual presenter.

1. A visual presenter comprising:
A platform having an upward facing flat light-transmitting surface with background lighting underneath said surface and plurality of foreground lighting sources above the surface, an image capturing device with optics mounted on a supporting structure such that the said image capturing device is above the said surface,
one or more video output,
plurality of input video sources,
a built-in central control system comprising first means to select input video sources and allow selected input video to be converted and presented at selected video output, second means to control the said image capturing device.

2. The visual presenter of claim 1, wherein said input video sources are paired with stereo audio inputs and the said built-in central control system comprises means to switch stereo audio sources along with the paired video sources.

3. The visual presenter of claim 1, wherein said video inputs include one or more RGB input, one or more S-Video input, and one or more Composite video input.

4. The visual presenter of claim 3, wherein said video output can be in the format of RGB, S-Video or Composite video.

5. The visual presenter of claim 4, wherein one of the said outputs is in RGB format and conversion of video inputs to RGB includes a) Composite video to RGB; b) S-Video to RGB.

6. The visual presenter of claim 1, wherein said built-in central control system further comprising third means to remotely control external display device, fourth means to power on and power off the said external display device.

7. The visual presenter of claim 1, wherein said built-in central control system further comprising means to control the up and down movements of an electronic projector screen.

8. The visual presenter of claim 1, wherein said outputs are individually connected to the designated inputs when the said visual presenter is in Stand-by mode.

9. The visual presenter of claim 1, wherein a universal remote control is incorporated to control the operation (power on/off, play, reverse, forward, pause, stop) of external devices such as VCRs, DVD players of various brands and makes, and ambient lighting.

10. The visual presenter of claim 1, wherein a PC is attached as one of the input sources and an electronic whiteboard is connected to the said PC such that the video signal from the whiteboard can be transmitted through the visual presenter to be further displayed on an external projector. The said built-in control system of the visual presenter of claim 1 further comprises means to switch the input from the said electronic whiteboard.

11. A visual presenter comprising:
A visualizer platform having an upward facing flat light-transmitting surface with background lighting underneath on which documents or other objects can be placed, plurality of foreground lighting sources above the surface, an image capturing device with optics mounted on a supporting structure such that the said image capturing device is perpendicularly above the said surface,
first video input in RGB format,
second video input in RGB format with stereo audio input,
one video input in S-Video format with stereo audio input,
one video input in Composite video format with stereo audio input,
one video output in RGB format linked directly to the first video input in RGB format,
one video output in RGB format able to accept signal through the switch controlled by central control system directly from video inputs in RGB format and from inputs in S-Video and Composite video formats after conversion.
one video output in S-Video format able to accept signal through the switch controlled by central control system directly from video input in S-Video format and from input in Composite video format after conversion.
one video output in Composite video format able to accept signal through the switch controlled by central control system directly from video input in Composite video format and from input in S-Video format after conversion.
Built-in central control system comprising means to select input video sources and allow selected input video to be converted and presented at selected video output, means to power on and power off the said presentation unit, means to control the said image capturing device including zooming, and means to remotely control (power on/off a projector and switch projector input sources) external display unit such as a video projector if so-equipped.
video outputs are individually connected to the designated inputs when the said visual presenter is in Stand-by mode.

12. The visual presenter of claim 11, wherein said built-in central control system further comprising means to control the up and down movements of an electronic projector screen.

13. The visual presenter of claim 11, wherein a universal remote control is incorporated to control the operation (power on/off, play, reverse, forward, pause, stop) of external devices such as VCRs, DVD players of various brands and makes, and ambient lighting.

14. The visual presenter of claim 11, wherein a PC is attached as one of the input sources and an electronic whiteboard is connected to the said PC such that the video signal from the whiteboard can be transmitted through the visual presenter to be further displayed on an external projector. The said built-in control system of the visual presenter of claim 10 further comprises means to switch the input from the said electronic whiteboard.
